(19) United States
(12) Patent Application Publication
(10) Pub. No.: US 2019/0346875 A1
(43) Pub. Date: Nov. 14, 2019

(54) Clock management circuit and clock management method

(71) Applicant: REALTEK SEMICONDUCTOR CORPORATION, Hsinchu (TW)

(72) Inventor: MING-CHING CHENG, Tainan City (TW)

(21) Appl. No.: 16/382,767

(22) Filed: Apr. 12, 2019

(30) Foreign Application Priority Data
May 11, 2018 (TW) 107116013

(51) Int. Cl. G06F 1/06; G06F 1/10

(52) U.S. Cl. CPC G06F 1/06; G06F 1/10

(57) ABSTRACT

The invention discloses a clock management circuit and a clock management method. The clock management circuit aims at managing a clock of a calculation circuit. The calculation circuit changes the level of a state signal according to an interrupt signal. The clock management circuit includes a delay circuit and a clock adjustment circuit. The delay circuit delays the interrupt signal or the state signal to generate a delay signal. The clock adjustment circuit is configured to control the frequency of the clock to change from a first frequency to a second frequency according to the delay signal, so that the calculation circuit first operates based on the first frequency of the clock after the interrupt signal has a level transition, and then operates based on the second frequency of the clock. The second frequency is greater than the first frequency.

### BACKGROUND OF THE INVENTION

### 1. Field of the Invention

The present invention generally relates to clock management, and, more particularly, to clock management circuits and clock management methods for high speed circuits.

### 2. Description of Related Art

In general, because of clock gating, a computing circuit consumes less power in an idle state than in an active state. When the computing circuit switches from the idle state to the active state, that is, when the computing circuit is woken up, there is often an instantaneous current peak (i.e., current surge) as a result of the instantaneous power extraction due to the clock gating being turned on, causing supply voltage drop (IR drop) on the printed circuit board on which the computing circuit is mounted. When the supply voltage drop on the printed circuit board exceeds the tolerance value, the computing circuit may behave unexpectedly, resulting in the failure of the circuit functions. Although it is feasible to add a capacitor on the printed circuit board to stabilize the supply voltage, adding the capacitor causes an increase in cost. Therefore, the present invention provides a circuit design to mitigate current surges (i.e., to reduce the IR drop).

The foregoing computing circuit is, for example, a high-speed circuit such as a central processing unit (CPU), a core of a CPU, a microcontroller, and a microprocessor. The active state can also be referred to as the full speed state.

### SUMMARY OF THE INVENTION

In view of the issues of the prior art, an object of the present invention is to provide clock management circuits and clock management methods for reducing current surge, so as to make an improvement to the prior art.

A clock management circuit for managing a clock of a computing circuit is provided. The computing circuit changes a level of a state signal according to an interrupt signal. The clock management circuit includes a delay circuit and a clock adjustment circuit. The delay circuit is configured to delay the interrupt signal or the state signal to generate a delay signal. The clock adjustment circuit, which is coupled to the computing circuit and the delay circuit, is configured to control a frequency of the clock to change from a first frequency to a second frequency according to the delay signal, so that after a level transition occurs to the interrupt signal, the computing circuit first operates according to the first frequency of the clock and then operates according to the second frequency of the clock. The second frequency is greater than the first frequency.

A clock management method for managing a clock of a computing circuit is also provided. The computing circuit changes a level of a state signal according to an interrupt signal. The clock management method includes steps of: delaying the interrupt signal or the state signal to generate a delay signal; and controlling a frequency of the clock to change from a first frequency to a second frequency according to the delay signal, so that after a level transition occurs to the interrupt signal, the computing circuit first operates according to the first frequency of the clock and then operates according to the second frequency of the clock. The second frequency is greater than the first frequency.

A clock management circuit for managing a clock of a computing circuit is also provided. The computing circuit changes a level of a state signal according to an interrupt signal. The clock management circuit includes a clock adjustment circuit that is coupled to the computing circuit and configured to control a frequency of the clock to change from a first frequency to a second frequency according to the state signal and to control the frequency of the clock to change from the second frequency to the first frequency according to the interrupt signal or the state signal, so that after a level transition occurs to the interrupt signal or the state signal, the computing circuit first operates according to the second frequency of the clock and then operates according to the first frequency of the clock. The first frequency being greater than the second frequency.

A clock management method for managing a clock of a computing circuit is also provided. The computing circuit changes a level of a state signal according to an interrupt signal. The clock management method includes steps of: controlling a frequency of the clock to change from a first frequency to a second frequency according to the state signal; and controlling the frequency of the clock to change from the second frequency to the first frequency according to the interrupt signal or the state signal, so that after a level transition occurs to the interrupt signal or the state signal, the computing circuit first operates according to the second frequency of the clock and then operates according to the first frequency of the clock. The first frequency is greater than the second frequency.

A clock management method for managing a clock of a computing circuit is also provided. The computing circuit changes a level of a state signal according to an interrupt signal. The clock management method includes steps of: providing the computing circuit with a first clock when the state signal is at a first level; providing the computing circuit with a second clock within a time length that follows the state signal's transition from the first level to a second level; providing the computing circuit with a third clock if the state signal is at the second level when the time length ends; and providing the computing circuit with the first clock if the state signal is at the first level when the time length ends. The frequency of the second clock is smaller than the frequency of the third clock.

By providing a computing circuit with a clock for a period of time after the computing circuit is woken up, the clock management circuits and the clock management methods of the present invention can reduce the toggle rate of the clock of the computing circuit during the wake-up process to thereby avoid or reduce current surges. The frequency of the clock provided is lower than an operating frequency used in the active state of the computing circuit. Compared with the prior art, the clock management circuits and the clock management methods of the present invention can reduce the number of capacitors mounted on the printed circuit board, thereby saving cost.

These and other objectives of the present invention no doubt become obvious to those of ordinary skill in the art after reading the following detailed description of the preferred embodiments with reference to the various figures and drawings.

### BRIEF DESCRIPTION OF THE DRAWINGS

FIG. 1 illustrates a functional block diagram of a clock management circuit according to an embodiment of the present invention.

FIG. 2 illustrates a flowchart of a clock management method according to an embodiment of the present invention.

FIG. 3 shows a timing diagram of the signals in FIG. 1.

FIG. 4 illustrates a circuit diagram of a clock adjustment circuit according to an embodiment of the present invention.

FIG. 5 shows a timing diagram of the signals in FIG. 4.

FIG. 6 illustrates a circuit diagram of a gating pulse generator according to an embodiment of the present invention.

FIG. 7 shows a timing diagram of the signals in FIG. 6.

FIG. 8 illustrates a functional block diagram of a clock management circuit according to another embodiment of the present invention.

FIG. 9 shows a flowchart of a clock management method according to another embodiment of the present invention.

FIG. 10 shows a flowchart of a clock management method according to another embodiment of the present invention.

### DETAILED DESCRIPTION OF THE EMBODIMENTS

The following description is written by referring to terms of this technical field. If any term is defined in this specification, such term should be explained accordingly. In addition, the connection between objects or events in the below-described embodiments can be direct or indirect provided that these embodiments are practicable under such connection. Said “indirect” means that an intermediate object or a physical space exists between the objects, or an intermediate event or a time interval exists between the events.

The disclosure herein includes clock management circuits and clock management methods. On account of that some or all elements of the clock management circuits could be known, the detail of such elements is omitted provided that such detail has little to do with the features of this disclosure and this omission nowhere dissatisfies the specification and enablement requirements. The clock management methods can be performed by the clock management circuits or its equivalent. A person having ordinary skill in the art can choose components or steps equivalent to those described in this specification to carry out the present invention, which means that the scope of this invention is not limited to the embodiments in the specification.

In the following description, signals are active-high, which means that signals are active at high levels and inactive at low levels, and that asserting/de-asserting a signal means setting the signal high/low. This is for the purpose of explanation, not for limiting the scope of the invention. In other words, in an alternative implementation, signals can be active-low, which means that signals are active at low levels and inactive at high levels, and that asserting/de-asserting a signal means setting the signal low/high. A level transition or a logic level transition means that a signal changes from an asserted (active) state to a de-asserted (inactive) state, or from a de-asserted (inactive) state to an asserted (active) state.

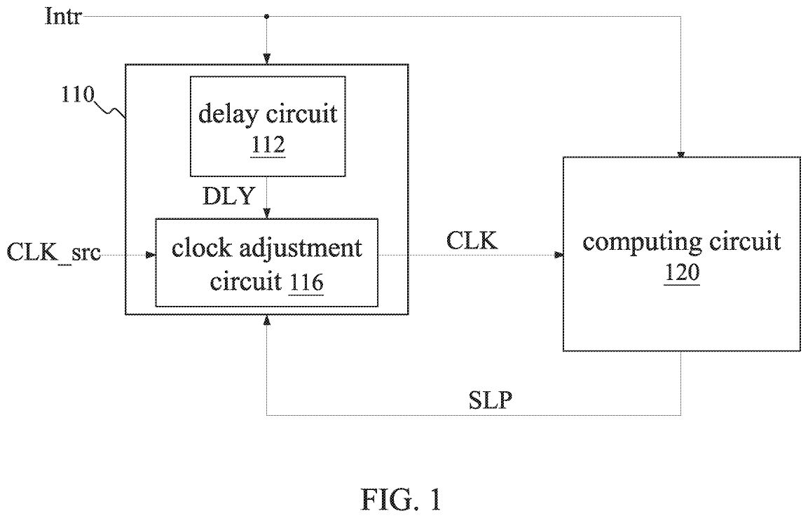

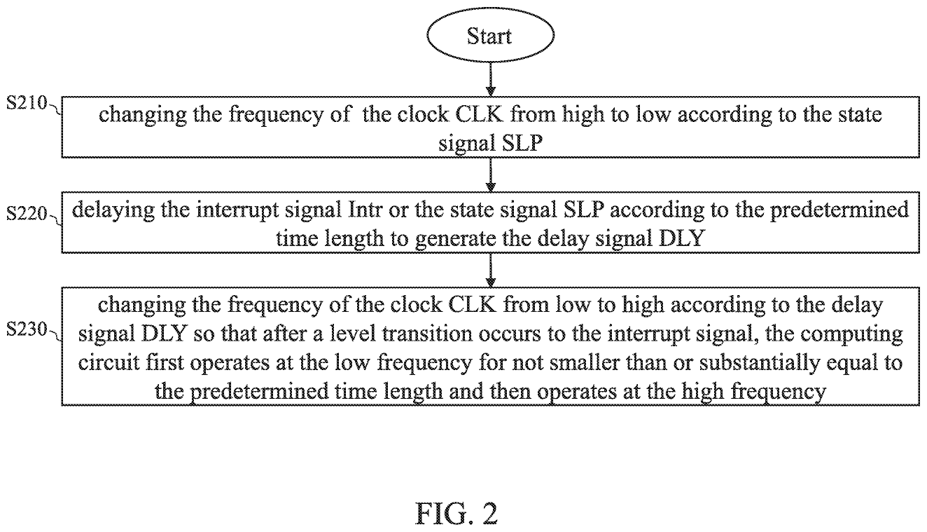

FIG. 1 is a functional block diagram of a clock management circuit according to an embodiment of the present invention. FIG. 2 is a flowchart of a clock management method according to an embodiment of the present invention. The flowchart of FIG. 2 corresponds to the circuit of FIG. 1. The clock management circuit 110 is configured to manage the clock of the computing circuit 120 and includes a delay circuit 112 and a clock adjustment circuit 116. The computing circuit 120 operates in accordance with the operating clock CLK. The state signal SLP indicates whether the computing circuit 120 is operating in an idle state or an active state. For example, the state signal SLP is inactive while the computing circuit 120 is operating in the active state and active while the computing circuit 120 is operating in the idle state.

The clock adjustment circuit 116 adjusts the frequency of the operating clock CLK according to the state signal SLP. More specifically, when the clock adjustment circuit 116 detects that the computing circuit 120 is operating in the active state (e.g., detects that the state signal SLP is de-asserted), the clock adjustment circuit 116 causes the frequency of the operating clock CLK to be equal to the frequency of the source clock CLK_src. When the clock adjustment circuit 116 detects that the computing circuit 120 is operating in the idle state (e.g., detects that the state signal SLP is asserted), the clock adjustment circuit 116 causes the frequency of the operating clock CLK to be smaller than the frequency of the source clock CLK_src (step S210). The clock adjustment circuit 116 can adjust the frequency of the operating clock CLK using clock gating technology, and the duty cycle of the operating clock CLK that is clock gated may not be 50%. Since the computing circuit 120 operates at a lower frequency in the idle state than in the active state, the computing circuit 120 consumes less power in the idle state than in the active state.

The computing circuit 120 leaves the idle state and enters the active state upon detecting that the interrupt signal Intr changes from the de-asserted state to the asserted state; accordingly, the state signal SLP also changes from the asserted state to the de-asserted state to reflect the level transition of the interrupt signal Intr. The delay circuit 112 delays the interrupt signal Intr or the state signal SLP according to a predetermined time length to thereby generate the delay signal DLY (step S220). Then, the clock adjustment circuit 116 changes the frequency of the operating clock CLK from low to high according to the delay signal DLY (for example, by ceasing clock gating). As a result, after receiving the interrupt signal Intr (or after a level transition occurs to the interrupt signal Intr), the computing circuit 120 first operates at the low frequency for substantially the predetermined time length and then operates at the high frequency (step S230). It should be noted that delaying the state signal SLP is substantially equivalent to delaying the interrupt signal Intr because whether the state signal SLP is asserted is associated with whether the interrupt signal Intr is asserted.

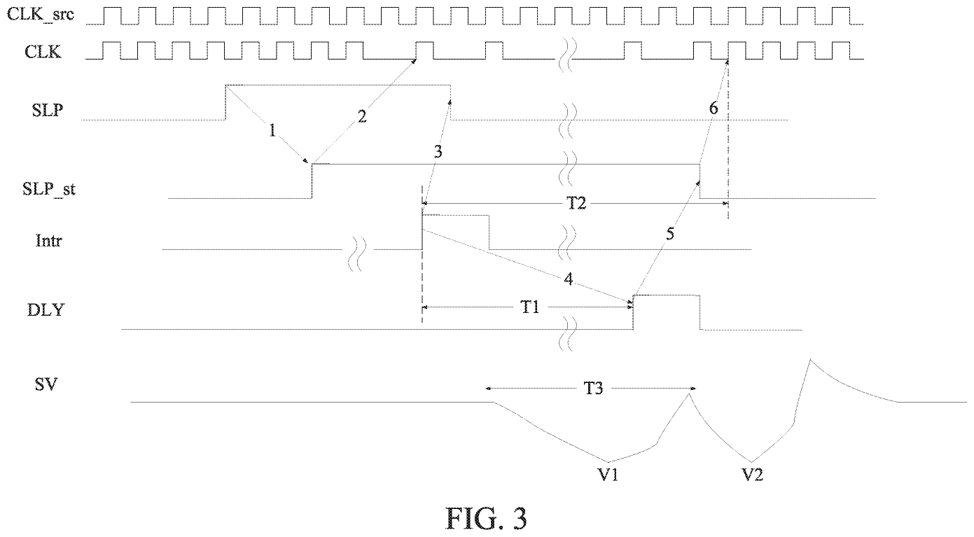

FIG. 3 shows a timing diagram of the signals in FIG. 1. When the clock adjustment circuit 116 detects that the state signal SLP is asserted, the state signal SLP_st inside the clock adjustment circuit 116 also becomes asserted (as indicated by the dashed arrow 1). The clock adjustment circuit 116 gates the source clock CLK_src according to the asserted state signal SLP_st so that the frequency of the operating clock CLK becomes lower than the frequency of the source clock CLK_src (as indicated by the dashed arrow 2) (step S210). Then, when detecting that the interrupt signal Intr is asserted, the computing circuit 120 causes the state signal SLP to change from the asserted state to the de-asserted state (as indicated by the dashed arrow 3). After a predetermined time length T1 from the assertion of the interrupt signal Intr, the delay signal DLY also becomes asserted (as indicated by the dashed arrow 4) (step S220). The asserted delay signal DLY causes the state signal SLP_st to become de-asserted (as indicated by the dashed arrow 5), thereby causing the clock adjustment circuit 116 to change the frequency of the operating clock CLK from low to high (as indicated by the dashed arrow 6) (Step S230). A time length time T2 passes or elapses from the interrupt signal Intr changing from the de-asserted state to the asserted state to the computing circuit 120 starting to operate at the high frequency or at full speed, and the time length T2 is not smaller than or substantially equal to the predetermined time length T1. In other words, after receiving the interrupt signal Intr, the computing circuit 120 first operates at the low frequency for not smaller than or substantially equal to the predetermined time length T1 and then operates at the high frequency (step S230).

The lowermost portion of FIG. 3 shows the change in the supply voltage SV. The first drop V1 of the supply voltage SV occurs because the computing circuit 120 is woken up (i.e., leaving the idle state and entering the active state), and the second drop V2 occurs because the operating clock CLK of the computing circuit 120 switches from the low frequency to the high frequency. If the computing circuit 120 operates at the high frequency or at full speed immediately after being woken up, the first drop V1 is likely to cause the supply voltage SV to fall below the tolerance of the circuit, causing an error in the circuit. In other words, the mechanism of the present invention can effectively prevent errors in the circuit.

In some embodiments, the delay circuit 112 can be implemented by a timer or counter. The predetermined time length T1 is adjustable and may be substantially equal to or not smaller than a time length T3. The time length T3 is an approximate time from the start to the end of the first drop V1 of the power supply voltage SV, and the end of the first drop V1 is the time at which the power supply voltage SV restores to its normal or stable voltage. It should be noted that, in some embodiments, if the delay circuit 112 delays the state signal SLP in step S220, the delay circuit 112 does not delay the state signal SLP when the state signal SLP changes from the de-asserted state to the asserted state (i.e., when the computing circuit 120 leaves the active state and enters the idle state), but delays the state signal SLP only when the state signal SLP changes from the asserted state to the de-asserted state (i.e., when the computing circuit 120 leaves the idle state and enters the active state).

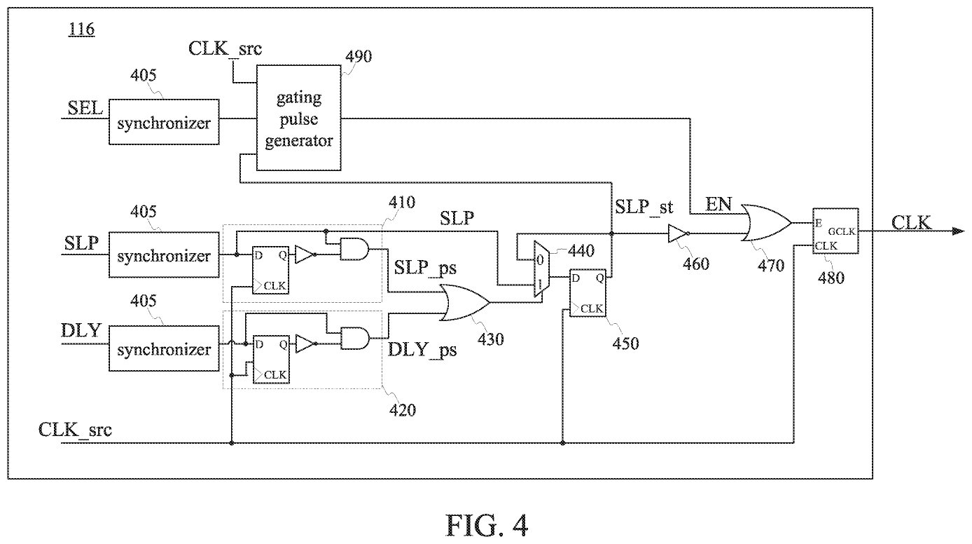

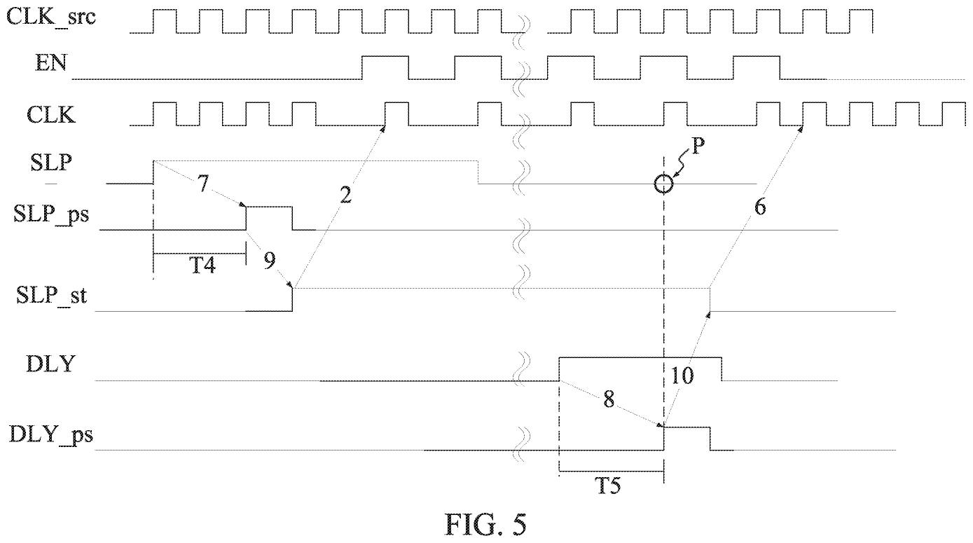

FIG. 4 is a circuit diagram of a clock adjustment circuit 116 according to an embodiment of the present invention. FIG. 5 shows a timing diagram of the signals in FIG. 4. The function of the synchronizer 405 is to synchronize the selection signal SEL, the state signal SLP and the delay signal DLY to avoid insufficient timing margin. If, however, the three signals belong to the same clock domain, the synchronizer 405 can be omitted. The logic circuit 410 and the logic circuit 420 are respectively configured to detect the level transitions of the state signal SLP and the delay signal DLY (e.g., changing from the de-asserted state to the asserted state), and the operation principles of the logic circuit 410 and the logic circuit 420 are well known to those of ordinary skill in the art and are thus omitted for brevity. As shown in FIG. 5, after a time length T4 from the assertion of the state signal SLP, the signal SLP_ps is asserted (as indicated by the dashed arrow 7). After a time length T5 from the assertion of the delay signal DLY, the signal DLY_ps is asserted (as indicated by the dashed arrow 8). The time length T4 and the time length T5, which are equal, are the delays produced by the synchronizers 405.

The OR gate 430, the multiplexer 440, and the D flip-flop 450 together determine the level of the state signal SLP_st. When the signal SLP_ps and the signal DLY_ps are both de-asserted, the level of the state signal SLP_st remains unchanged. When either of the signal SLP_ps and the signal DLY_ps is asserted, the level of the state signal SLP_st varies with the level of the state signal SLP (as indicated by the dashed arrows 9 and 10). More specifically, at the dashed arrow 9, the asserted state signal SLP causes the state signal SLP_st to change from the de-asserted state to the asserted state; at the dashed arrow 10, the de-asserted state signal SLP causes the state signal SLP_st to change from the asserted state to the de-asserted state.

It should be noted that the timing changes corresponding to the dashed arrows 8 and 10 reflect the end of the predetermined time length T1. In this instance, if the state signal SLP is asserted (i.e., the computing circuit 120 is in the idle state), the state signal SLP_st is asserted to indicate that a low-frequency operating clock CLK may be provided to the computing circuit 120 (e.g., by gating the source clock CLK_src); on the other hand, if, in this instance, the state signal SLP is de-asserted (as indicated by the point P in FIG. 5 at which the computing circuit 120 is in the active state), the state signal SLP_st is de-asserted to indicate that a high-frequency operating clock CLK may be provided to the computing circuit 120 (e.g., by providing the source clock CLK_src).

The integrated clock gating (ICG) cell 480 gates the source clock CLK_src according to the state signal SLP_st and the gating pulse EN. In this embodiment, the operating clock CLK is the intersection of the source clock CLK_src and the output signal of the OR gate 470. In other words, when the state signal SLP_st is at the low level (i.e., the output of the inverter 460 is high), the operating clock CLK is equal to the source clock CLK_src (i.e., the ICG cell is not gating). It should be noted that when both the signal DLY_ps and the state signal SLP are asserted (i.e., the computing circuit 120 is still in the idle state when the signal DLY_ps is asserted), the state signal SLP_st is asserted, so that the ICG cell 480 gates the source clock CLK_src according to the gating pulse EN to thereby lower the frequency of the operating clock CLK. The gating pulse generator 490 generates the gating pulse EN according to the source clock CLK_src, the selection signal SEL, and the state signal SLP_st.

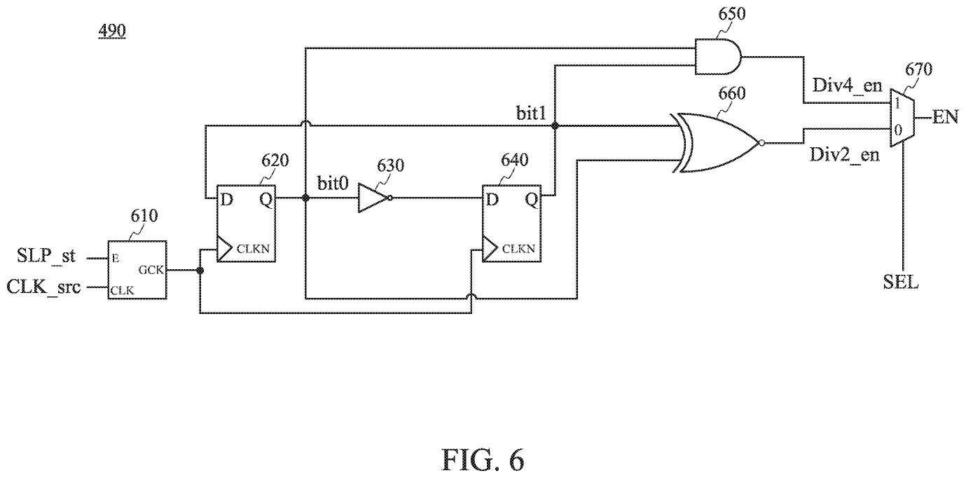

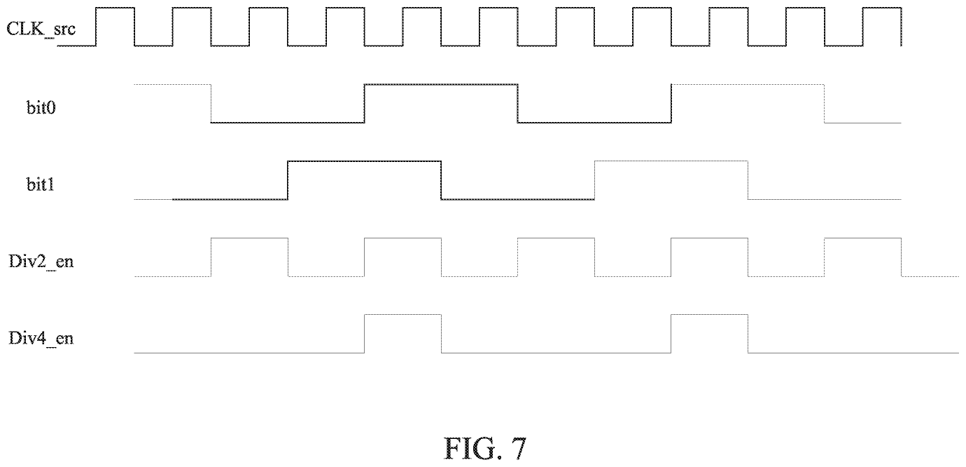

FIG. 6 is a circuit diagram of a gating pulse generator 490 according to an embodiment of the present invention. FIG. 7 shows a timing diagram of the signals in FIG. 6. The gating pulse generator 490 includes an ICG cell 610, a D flip-flop 620, an inverter 630, a D flip-flop 640, an AND gate 650, an Exclusive-OR (XOR) gate 660, and a multiplexer 670. In this embodiment, the output of the ICG cell 610 is an intersection of the source clock CLK_src and the state signal SLP_st; in other words, the D flip-flop 620 and the D flip-flop 640 operate according to the source clock CLK_src only when the state signal SLP_st is asserted. As shown in FIG. 7, the circuit of FIG. 6 operates in accordance with the falling edges of the signals, but FIG. 7 is for the purpose of explanation, not for limiting the scope of the invention. Those skilled in the art can understand the operations of the circuits of FIG. 6 with reference to FIG. 7, and therefore the details are omitted for brevity. The signal bit0 and the signal bit1 are the outputs of the D flip-flop 620 and the D flip-flop 640, respectively. The multiplexer 670 selects the signal Div4_en or the signal Div2_en as the gating pulse EN according to the selection signal SEL. Although in this embodiment the frequencies of the signals Div2_en and Div4_en are respectively one-half and one-quarter of the source clock CLK_src, which is equivalent to dividing the source clock CLK_src by divisors of two and four, respectively, those skilled in the art can implement different divisors according to the disclosures of FIGS. 6 and 7.

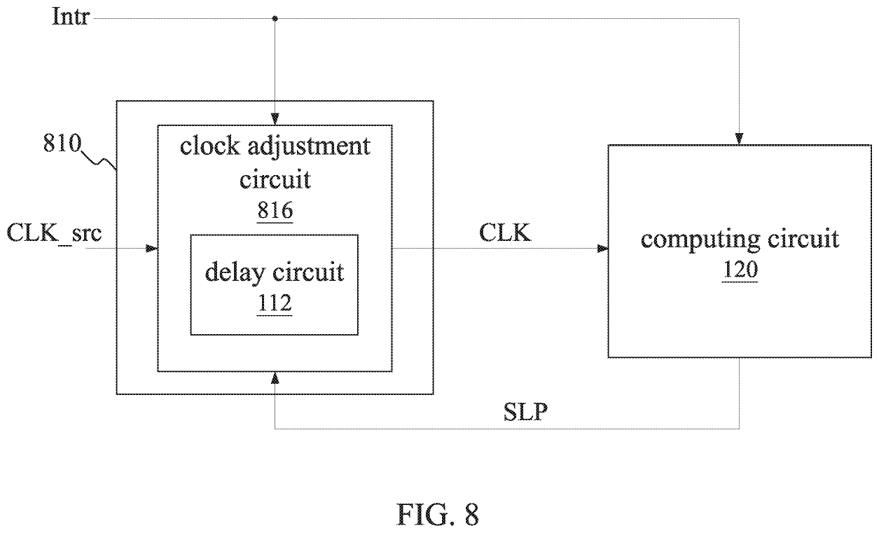

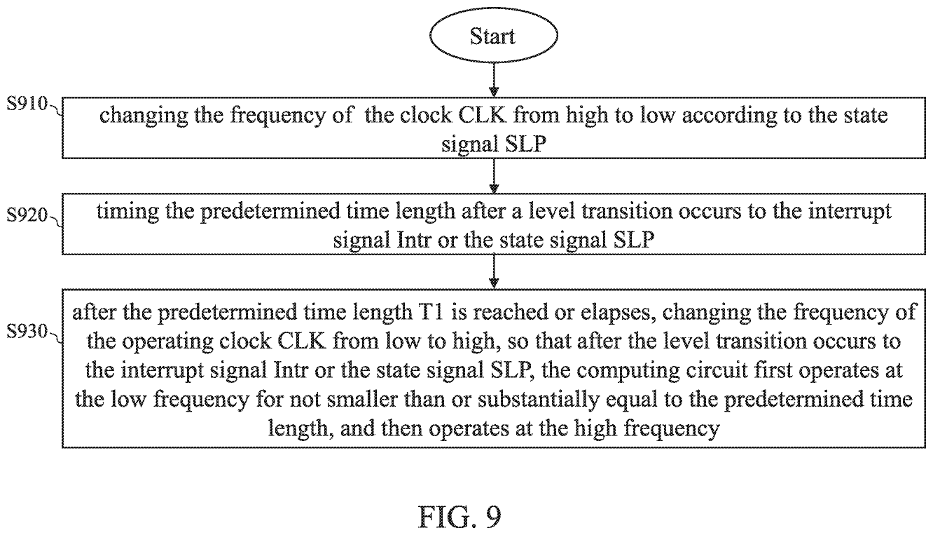

FIG. 8 is a functional block diagram of a clock management circuit according to another embodiment of the present invention. The clock management circuit 810 includes a clock adjustment circuit 816, and the clock adjustment circuit 816 includes a delay circuit 112. The clock adjustment circuit 816 adjusts the frequency of the operating clock CLK by gating the source clock CLK_src according to the interrupt signal Intr and/or the state signal SLP. FIG. 9 is a flowchart of a clock management method according to another embodiment of the present invention. The flowchart of FIG. 9 corresponds to the circuit of FIG. 8. The clock adjustment circuit 816 changes the frequency of the operating clock CLK from high to low according to the state signal SLP (step S910). The details of step S910 are similar to those of step S210 and thus omitted for brevity. Then, after the clock adjustment circuit 816 detects that a level transition occurs to the interrupt signal Intr and/or the state signal SLP, the clock adjustment circuit 816 controls the delay circuit 112 (e.g., a timer or a counter) to count the predetermined time length T1 (or count to a predetermined value) (step S920). Next, in step S930, after the predetermined time length T1 is reached or elapses, the clock adjustment circuit 816 controls the frequency of the operating clock CLK to change from low to high. As a result, after the level transition of the interrupt signal Intr or the state signal SLP, the computing circuit 120 first operates at the low frequency for not smaller than or substantially equal to the predetermined time length T1, and then operates at the high frequency.

Because referring to the interrupt signal Intr is substantially equivalent to referring to the state signal SLP, in some embodiments, the clock management circuit 110 of FIG. 1 and the clock management circuit 810 of FIG. 8 may not receive the interrupt signal Intr.

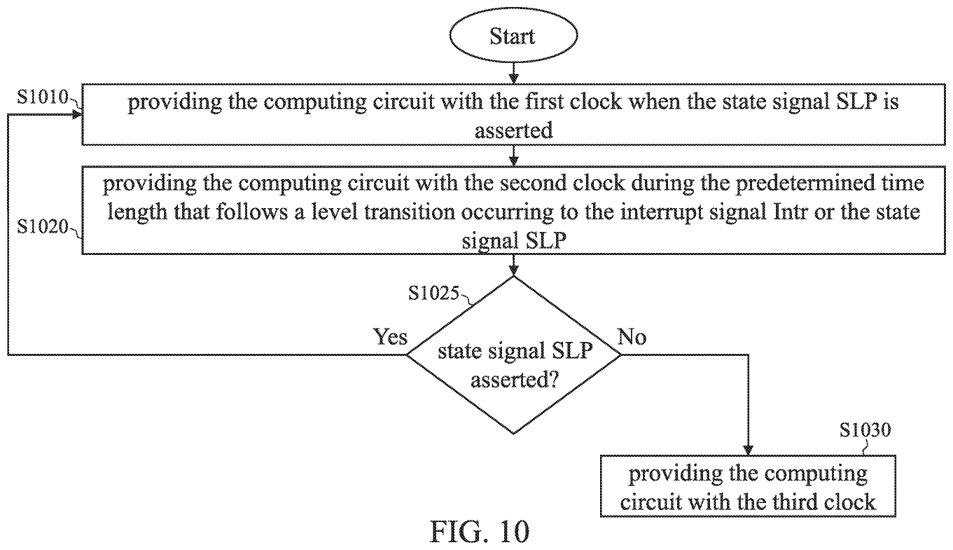

FIG. 10 is a flowchart of a clock management method according to another embodiment of the present invention. In this embodiment, the clock management circuit 110 and the clock management circuit 810 can provide the computing circuit 120 with a first clock (e.g., by controlling the operating clock CLK to be of a first frequency) when the computing circuit 120 is in the idle state (step S1010), and provide the computing circuit 120 with a second clock during the aforementioned predetermined time length T1 (e.g., by controlling the operating clock CLK to be of a second frequency) (step S1020). If the computing circuit 120 is in the active state when the predetermined time length T1 ends or is reached/over (step S1025 being negative), the clock management circuit 110 and the clock management circuit 810 provide the computing circuit 120 with a third clock (e.g., by controlling the operating clock CLK to be of a third frequency) (step S1030). If the computing circuit 120 is in the idle state when the predetermined time length T1 ends or is reached/over (step S1025 being positive), the clock management circuit 110 and the clock management circuit 810 provide the computing circuit 120 with the first clock (back to step S1010). The frequency of the second clock is smaller than the frequency of the third clock and is greater than or equal to the frequency of the first clock. Techniques for generating different frequencies using clock gating are well known to those of ordinary skill in the art and are thus omitted for brevity.

The computing circuit 120 can be a central processing unit or a core of the central processing unit. The present invention can be applied to multiple cores simultaneously to regulate or manage the clocks of the respective cores.

Since a person having ordinary skill in the art can appreciate the implementation detail and the modification thereto of the present method invention through the disclosure of the device invention, repeated and redundant description is thus omitted. Please note that there is no step sequence limitation for the method inventions as long as the execution of each step is applicable. Furthermore, the shape, size, and ratio of any element and the step sequence of any flow chart in the disclosed figures are exemplary for understanding, not for limiting the scope of this invention. Furthermore, although the foregoing embodiments are exemplified by a computing circuit, this is not a limitation the present invention. Those skilled in the art can appropriately apply the present invention to other types of high speed circuits in accordance with the disclosure of the present invention.

The aforementioned descriptions represent merely the preferred embodiments of the present invention, without any intention to limit the scope of the present invention thereto. Various equivalent changes, alterations, or modifications based on the claims of the present invention are all consequently viewed as being embraced by the scope of the present invention.

What is claimed is:

1. A clock management circuit for managing a clock of a computing circuit, the computing circuit changing a level of a state signal according to an interrupt signal, the clock management circuit comprising:
a delay circuit configured to delay the interrupt signal or the state signal to generate a delay signal; and
a clock adjustment circuit coupled to the computing circuit and the delay circuit and configured to control a frequency of the clock to change from a first frequency to a second frequency according to the delay signal, so that after a level transition occurs to the interrupt signal, the computing circuit first operates according to the first frequency of the clock and then operates according to the second frequency of the clock;
wherein the second frequency is greater than the first frequency.

2. The clock management circuit of claim 1, wherein the delay circuit delays the interrupt signal or the state signal for a first time length, and after the level transition occurs to the interrupt signal, the computing circuit operates according to the first frequency of the clock for a second time length and then operates according to the second frequency of the clock, the second time length being substantially equal to the first time length.

3. The clock management circuit of claim 1, wherein the clock adjustment circuit further controls the frequency of the clock to change from the second frequency to the first frequency according to the state signal.

4. A clock management method for managing a clock of a computing circuit, the computing circuit changing a level of a state signal according to an interrupt signal, the clock management method comprising:
delaying the interrupt signal or the state signal to generate a delay signal; and
controlling a frequency of the clock to change from a first frequency to a second frequency according to the delay signal, so that after a level transition occurs to the interrupt signal, the computing circuit first operates according to the first frequency of the clock and then operates according to the second frequency of the clock;
wherein the second frequency is greater than the first frequency.

5. The clock management method of claim 4, wherein the interrupt signal or the state signal is delayed for a first time length, and after the level transition occurs to the interrupt signal, the computing circuit operates according to the first frequency of the clock for a second time length and then operates according to the second frequency of the clock, the second time length being substantially equal to the first time length.

6. The clock management method of claim 4 further comprising:
controlling the frequency of the clock to change from the second frequency to the first frequency according to the state signal.

7. A clock management circuit for managing a clock of a computing circuit, the computing circuit changing a level of a state signal according to an interrupt signal, the clock management circuit comprising:
a clock adjustment circuit coupled to the computing circuit and configured to control a frequency of the clock to change from a first frequency to a second frequency according to the state signal and to control the frequency of the clock to change from the second frequency to the first frequency according to the interrupt signal or the state signal, so that after a level transition occurs to the interrupt signal or the state signal, the computing circuit first operates according to the second frequency of the clock and then operates according to the first frequency of the clock, the first frequency being greater than the second frequency.

8. The clock management circuit of claim 7, wherein the clock adjustment circuit comprises:
a delay circuit timing for a time length after the level transition occurs to the interrupt signal or the state signal;
wherein the clock adjustment circuit controls the frequency of the clock to change from the second frequency to the first frequency after the time length is reached, and a time period during which the computing circuit operates according to the second frequency of the clock after the level transition occurs to the interrupt signal or the state signal is substantially equal to the time length.
